(19) United States
(12) Patent Application Publication
(10) Pub. No.: US 2011/0284171 A1
(43) Pub. Date: Nov. 24, 2011

(54) DEVICE FOR DETECTING THE PRESENCE OF AN OBJECT OR OF A LIVING BEING

(75) Inventor: Norbert Daniele, Bernin (FR)

(73) Assignees: Commissariat A L'Energie Atomique, Paris (FR); Bubendorff, Attenschwiller (FR)

(21) Appl. No.: 13/123,093

(22) PCT Filed: Oct. 7, 2009
(86) PCT No.: PCT/FR2009/051918

§ 371 Date: Jun. 6, 2011

(30) Foreign Application Priority Data
Oct. 7, 2008 (FR) 0856782

(51) Int. Cl. E05F 15/20

(52) U.S. Cl. 160/10

(57) ABSTRACT

The invention relates to a device for detecting the presence of an object or of a living being between two end points. This device comprises, on the one hand, a means for emitting an electromagnetic signal comprising an emit antenna associated with a first end point, and a means for exciting this antenna so as to make this antenna emit such a signal and, on the other hand, a means for receiving this electromagnetic signal comprising a receive antenna associated with a second end point, together with means for detecting such a signal. This detection device is characterized in that the emit and receive antennas each adopt the form of a tubular waveguide having at least one wall provided with at least one opening. The invention further relates to an installation for protecting, for counting or for closing an opening equipped with such a detection device.

The present invention relates to a detection device and to a counting installation, to a protection installation or an installation for closing an opening that is contained in a building or a swimming pool, such an installation being fitted with such a detection device.

This invention relates to the field of manufacturing devices that are designed to be capable of detecting a presence/absence, a movement or a position of a movable element relative to another element that is fitted with such a device.

Specifically, this invention will find a particularly appropriate, but wholly nonlimiting, application in the field of installations for the closing of an opening that is contained in a building or a swimming pool.

Accordingly, it will be observed that detection devices fitted to such installations are already known.

Thus, in document EP-1.092.833, an installation is described that adopts the form of a roller blind and is fitted with a detection device comprising, on the one hand, two sensors placed, in a spaced manner, on a runner inside which the end of the strips of a roller-blind apron is slidingly installed and, on the other hand, two actuators each installed so as to be associated with a different strip of this apron and each constituting, with a sensor, a switch operating without contact. Each actuator consists of a magnet transmitting a magnetic signal while each sensor consists of a magnetism-sensitive element such as a magnet. Such a sensor is capable of receiving the magnetic signal of such a magnet and is electrically connected to an alarm circuit reacting when the two actuators are moved simultaneously out of the switching zone of the sensors, which occurs, more particularly, under the effect of a lifting of the apron which occurs during a break-in attempt.

Such a detection device has the drawback of having actuators attached to the apron and moving in concert with this apron. During deployment, respectively folding, of the apron, these actuators enter the runners, respectively the casing, of the roller blind and are capable of coming into contact with these runners or this casing of the roller blind, and even of becoming hooked therein, causing damage to the installation and even causing it to malfunction.

Also known, through document EP-1.146.199, is a roller blind comprising a detection device adopting the form of a pyroelectric, notably infrared, detector. If an obstacle is detected in the trajectory of the apron, this detection device is designed to control the stopping of the operation of the motor for driving the apron and consequently for stopping the deployment of this apron.

Also known are roller blinds comprising, on the one hand, a motor for driving a means for deploying and folding the apron of such a blind and, on the other hand, a means for measuring the electrical characteristics of this motor, more particularly the current in this motor. When the apron comes into contact with an obstacle (notably when it reaches the end of its travel or in the event of contact with a person, an animal or an object), the load on the motor increases causing a variation in the current, the measurement of which, via the measurement means, causes a control to stop the operation of this motor.

The installations and the devices of the prior art make it possible, thus and only, to detect a single type of phenomenon consisting either of a break-in attempt perpetrated on the apron of a roller blind, or in the appearance of an obstacle on the trajectory of the apron during the deployment of the latter.

The object of the present invention is to remedy the drawbacks of the abovementioned detection devices and installations of the roller blind type and corresponding to the prior art, by means of a novel detection device and novel installations fitted with such a detection device. This invention also makes it possible to remedy drawbacks encountered for other types of installation of the prior art (notably swimming pools, counting or protection installations) through the use of this novel detection device for the production of novel installations of the abovementioned type.

Accordingly, the invention relates to a device for detecting the presence of an object or of a living being between two terminals, this device comprising, on the one hand, a means for transmitting an electromagnetic signal comprising a transmit antenna, associated with a first terminal, and a means for exciting this antenna for the purpose of transmitting such a signal via this antenna and, on the other hand, a means for receiving this electromagnetic signal comprising a receive antenna, associated with a second terminal, and a means for detecting such a signal. This device is characterized in that the transmit antenna and receive antenna each adopt the form of a tubular waveguide having at least one wall provided with at least one opening.

The invention also relates to an installation for counting a number of movable elements passing through a zone and comprising, on the one hand, a device for detecting the passage of at least one element through this zone and, on the other hand, a device for counting the number of movable elements detected by the detection device. This detection device, on the one hand, has the abovementioned characteristics and, on the other hand, comprises at least one transmit means and at least one receive means positioned on either side of the zone to be passed through.

The invention also relates to an installation for the protection of an object, notably a work of art, comprising, on the one hand, a device for detecting the presence of a living being or of a tool close to or in contact with this object and, on the other hand, a visual and/or audible warning device in the case of such a detection. This detection device, on the one hand, has the abovementioned characteristics and, on the other hand, comprises at least one transmit means and at least one receive means positioned on either side and in front of the object to be protected.

Finally, the invention relates to an installation for closing an opening contained in a building or a swimming pool and which comprises, on the one hand, lateral runners designed to be positioned facing one another, on either side of the opening and, on the other hand, an apron designed to close the opening and having lateral ends mounted slidingly inside the lateral runners. This installation also comprises a detection device having the abovementioned characteristics, and of which the transmit means and receive means each consist, at least in part, of a lateral runner or extend parallel to such a lateral runner, close to such a lateral runner or being fitted to such a lateral runner.

The advantages of the present invention consist in that the detection device operates on the principle of transmission and reception of an electromagnetic signal.

Another advantage consists in that the transmitted signal consists of a surface barrier capable of extending over the whole width and height of the opening or of the object to which the detection device is fitted.

An additional advantage consists in that the detection device is particularly versatile and makes it possible to envisage its use not only for various types of installations but also in the context of one and the same installation in order to detect different events also with the possibility of a distinct and appropriate response for one and the same detected event.

Other objects and advantages of the present invention will appear in the course of the following description relating to embodiments that are given only as indicative and nonlimiting examples.

This description will be made easier by referring to the attached drawings in which:

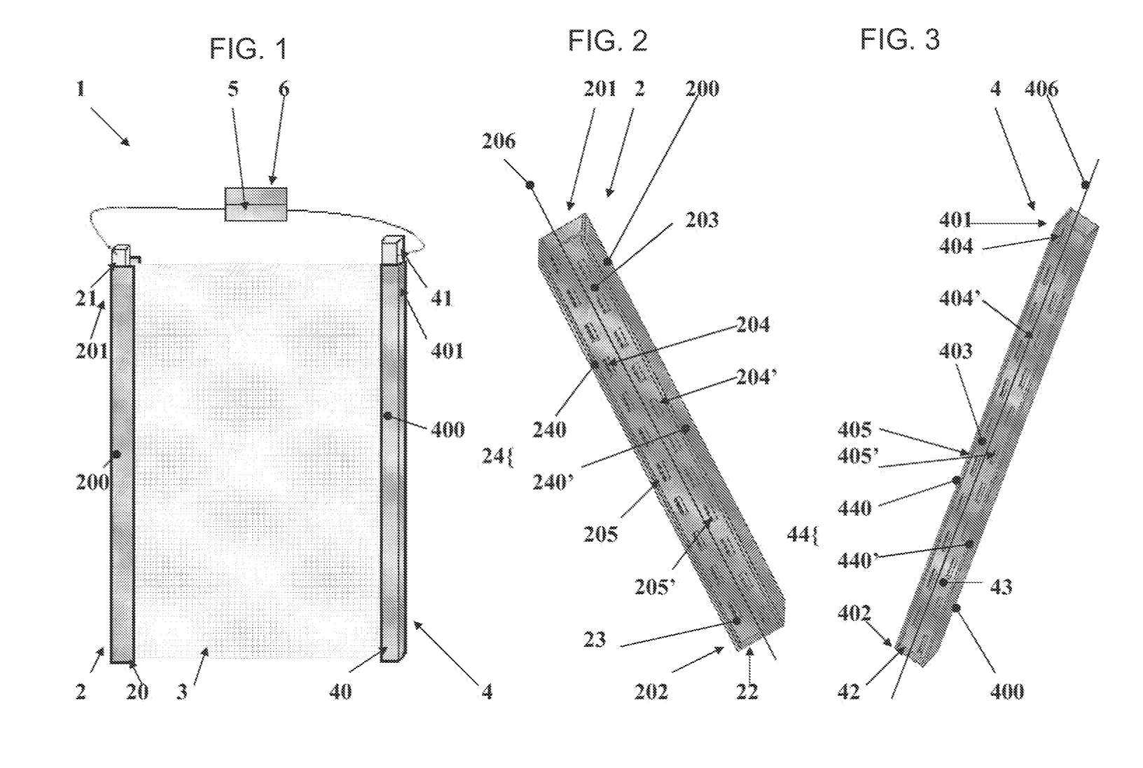

FIG. 1 is a schematic front view of a detection device according to the invention;

FIG. 2 is a partial schematic view in perspective of a transmit antenna for transmitting an electromagnetic signal, said antenna being contained in the device illustrated in FIG. 1;

FIG. 3 is a view similar to FIG. 2 corresponding to a receive antenna for receiving the electromagnetic signal;

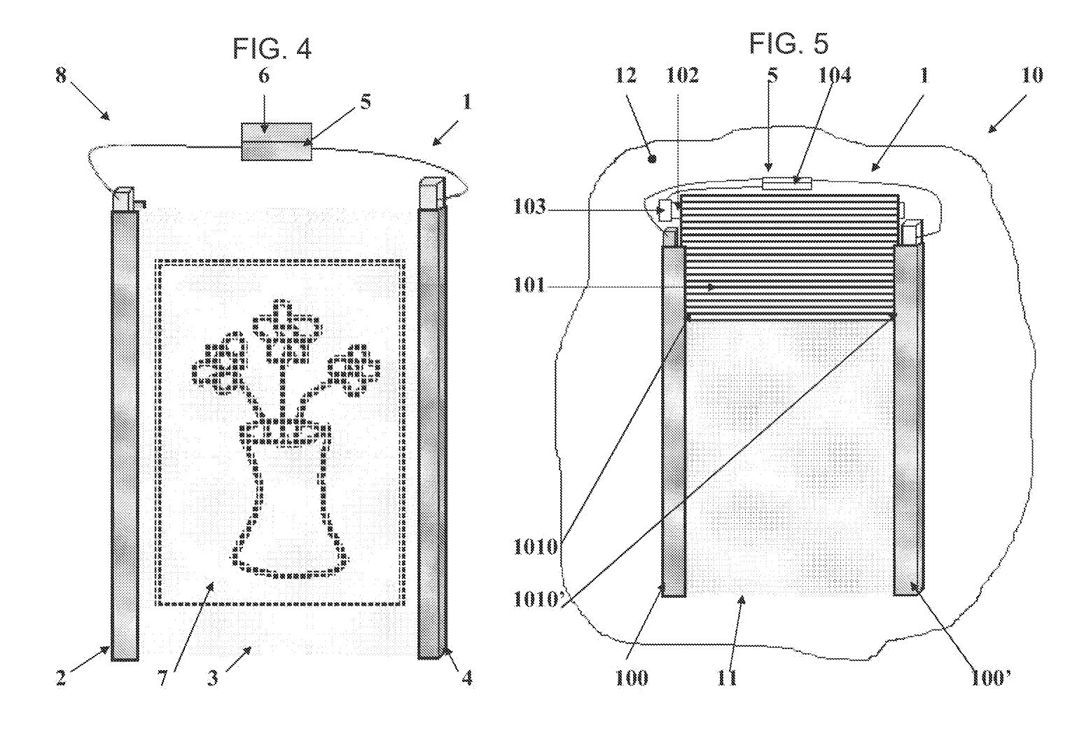

FIG. 4 is a schematic view of an installation for the protection of an object, this installation comprising a detection device as illustrated in FIG. 1;

FIG. 5 is a schematic view of an installation for closing an opening of a building, this installation comprising a detection device as illustrated in FIG. 1;

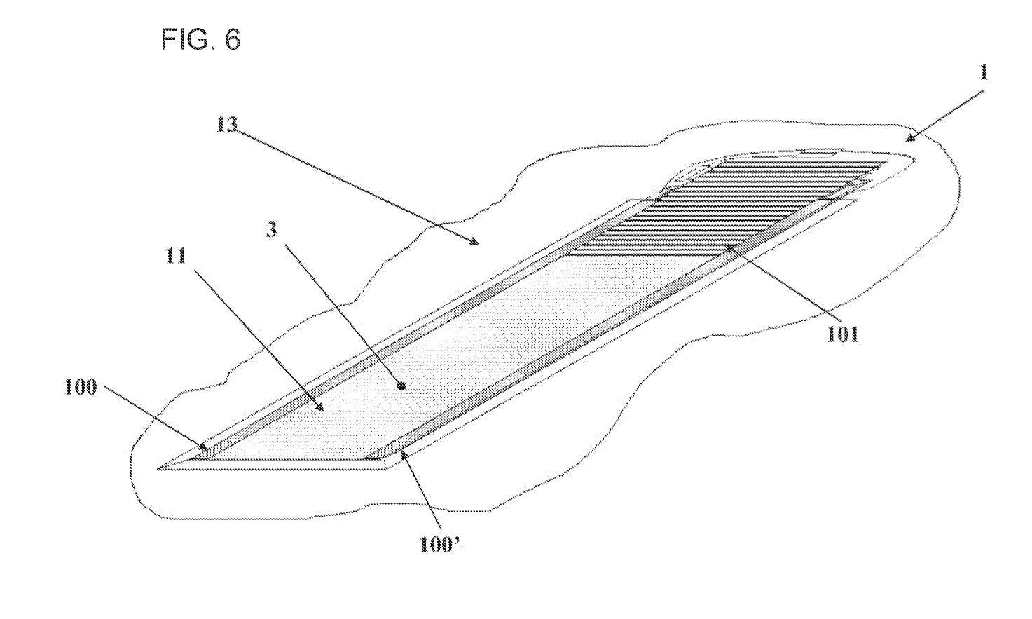

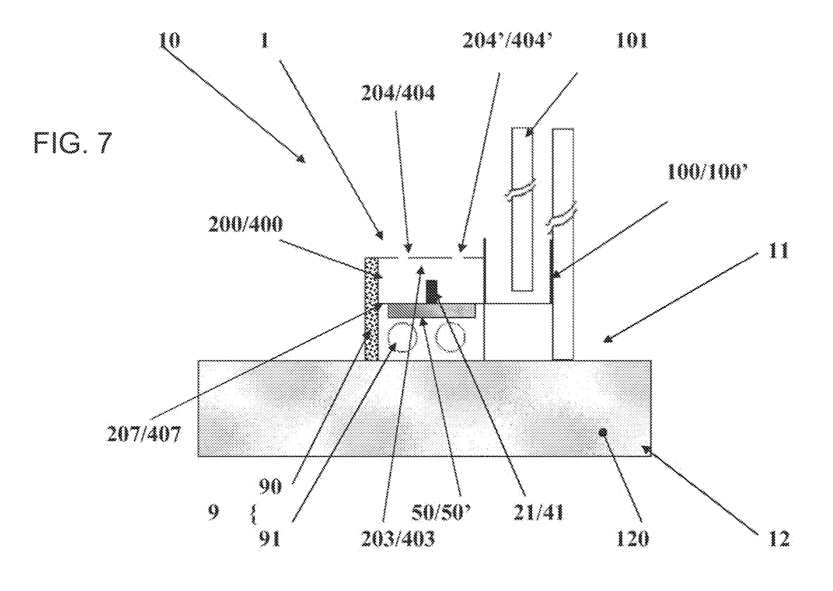

FIG. 6 is a schematic view of an installation for closing an opening of a swimming pool, this installation comprising a detection device as illustrated in FIG. 1;

FIG. 7 is a schematic view from above corresponding to a section made in a mid-zone of a waveguide and relating to another embodiment of a detection device according to the invention fitted to an opening of a building.

The invention relates to the field of manufacture of the devices 1 designed to be capable of detecting a presence, an absence, a movement or a position of a movable element relative to another element that is fitted with such a device 1.

More particularly, such a device 1 is designed to detect the presence of an object or of a living being between two terminals.

As can be seen in the appended figures, such a detection device 1 comprises, on the one hand, at least one means 2 for transmitting an electromagnetic signal 3 and, on the other hand, at least one means 4 for receiving such an electromagnetic signal 3.

With respect to the transmit means 2, the latter comprises, on the one hand, a transmit antenna 20 for transmitting such an electromagnetic signal 3 associated with a first terminal and, on the other hand, a means 21 for exciting this transmit antenna 20 for the purpose of transmitting such an electromagnetic signal 3 via this antenna 20.

This transmit antenna 20 adopts the form of a tubular waveguide 200 made of a metal material, preferably of aluminum.

As can be seen in FIG. 2, this tubular waveguide has a proximal end 201 and a distal end 202.

This tubular waveguide 200 consists, at least in part, of a section piece that is hollow and of parallelepipedal, preferably rectangular or square, cross section, so that this waveguide 200 then has a plurality of walls of which one 203 is oriented in the direction of the receive means 4.

Specifically, this hollow section piece of parallelepipedal cross section has internal, respectively external, dimensions corresponding to the (internal, respectively external) width of the walls of this waveguide 200.

In particular, the wall 203 oriented in the direction of the receive means 4 (and the wall 207 of the waveguide 200 that is parallel with it) has a determined internal width (a) while the walls extending from such a wall 203 have a determined internal width (b), depending on the case, that is equal to (in the case of a waveguide 200 of square cross section) or different from (in the case of a waveguide 200 of rectangular cross section) the width (a).

At least one wall of the waveguide 200 of this transmit antenna 20 (more particularly the wall 203 oriented in the direction of the receive means 4) is provided with at least one opening (204; 204′).

On this subject, it will be observed that the presence of at least one such opening (204; 204′) advantageously makes it possible to confer the functionalities of a transmit antenna 20, more particularly those of a device radiating an electromagnetic signal 3, on the wall 203 of the waveguide 200 provided with at least one such opening (204; 204′).

According to a particular embodiment illustrated in FIG. 2, the waveguide 200 actually comprises a plurality of openings (204; 204′) made in its wall 203 oriented in the direction of the receive means 3.

These openings (204; 204′) are preferably aligned in at least one row (205; 205′) of openings (204; 204′).

Within such a row (205; 205′), the openings (204; 204′) are positioned substantially in a location where the electromagnetic field is at a maximum.

In particular, the pitch (p) between two successive openings (204; 204′) of one and the same row (205; 205′) is between 2 and 6 times the guided wavelength divided by 2 (2*λg/2≦p≦6*λg/2), preferably of the order of 4 times this guided wavelength divided by 2 (p≈4*λg/2).

Such an embodiment advantageously makes it possible to distribute the electromagnetic field over the whole length of the waveguide 200.

A preferred embodiment of the invention illustrated in FIG. 2 then consists in that the waveguide 200 comprises two rows (205; 205′), preferably parallel, of openings (204; 204′).

These two rows (205, 205′):
are spaced at a distance corresponding substantially to half the width (more particularly the internal width a) of the wall 203 provided with the openings (204; 204′) and/or;
extend on either side of an axis (preferably parallel to this axis 406), this axis 206 preferably consisting of the median axis of the wall 203 provided with the openings (204; 204′) and contained in the waveguide 200.

As can be seen in this same FIG. 2, the openings 204 of one row 205 are preferably offset longitudinally relative to the openings 204′ of the other row 205′.

The opening or openings (204; 204′) may have any shape, for example a circular shape. However, and according to a preferred embodiment of the invention, this or these openings (204; 204′) have an elongate shape, more particularly oval, diamond-shaped or (and preferably) slot-shaped (such a slot preferably being of rectangular shape).

This or these openings (204; 204′) have a length (l) preferably corresponding to half the wavelength λ (l=λ/2).

This or these elongate openings (204, 204′) and/or an alignment of these (circular or elongate) openings extend in a manner substantially parallel to the longitudinal direction of extension of the waveguide 200 in which such an opening (204; 204′) is made.

The presence of an elongate opening (204) or of an alignment of openings (204; 204′) advantageously makes it possible to confer on the electromagnetic signal 3 the form of an intangible surface barrier.

Specifically, such a surface barrier has a certain thickness. More precisely, this intangible surface barrier has a height that is substantially equal to the length of the waveguides 200 and 400. Its width corresponds to the distance separating the two waveguides. Its thickness is for its part variable from one waveguide to the other. When close to either waveguide, its thickness corresponds substantially to the width of the waveguides. The thickness of the surface barrier is at a maximum halfway between the waveguides.

As mentioned above, the transmit means 2 also comprises a means 21 for exciting the transmit antenna 20.

On this subject, it should be observed that the excitation means 21 may consist of a system capable of transmitting a pure carrier such as a voltage-controlled oscillator.

However, such an excitation means 21 may also consist of a system capable of transmitting at least one modulation of such a pure carrier. Such a system may adopt the form of a diode oscillator or of a transistor oscillator, preferably a field-effect transistor.

According to another feature, this excitation means 21 is associated with the transmit antenna 20 while being engaged (at least in part) inside this waveguide 200.

According to a first embodiment illustrated in FIGS. 1, 4, 5 and 6, this excitation means 21 may be engaged inside this waveguide 200 at one end (notably the proximal end 201) of this waveguide 200.

In such a case, the transmit means 2 also comprises at least one means 22 for closing the waveguide 200. Such a closing means 22 is associated with at least one end (201, 202) of this waveguide 200 (more particularly with the distal end 202, opposite to the proximal end 201 at which the excitation means 21 is inserted into the waveguide 200) and preferably consists of a means for producing a short circuit.

However, and according to a preferred embodiment of the invention illustrated in FIG. 7, the waveguide 200 of the transmit antenna 20 receives internally the excitation means 21 which is, on the one hand, engaged inside this waveguide 200 and, on the other hand, positioned in a mid-zone of this waveguide 200 between the proximal end 201 and the distal end 202 of this waveguide 200.

A preferred embodiment consists in that this excitation means 21 is preferably positioned substantially equidistant from the proximal end 201 and from the distal end 202 of this waveguide 200.

Such an embodiment advantageously allows a better propagation and a better distribution of the field in the waveguide 200.

An additional feature consists in that the excitation means 21 is then positioned close to an opening (204; 204′) with which the wall 203 of the waveguide 200 of the transmit antenna 20 is provided, in a mid-zone of this waveguide 200, preferably substantially equidistant from the proximal end 201 and from the distal end 202 of this waveguide 200.

Additionally, this excitation means 21 is positioned in line with or through a through-orifice made in a wall 207 of the waveguide 200 parallel to the wall 203 provided with openings 204, 204′, in a mid-zone of this waveguide 200, preferably substantially equidistant from the proximal end 201 and from the distal end 202 of this waveguide 200.

Such an embodiment advantageously makes it possible to ensure a good match between the transmitter and the waveguide 200 which makes it possible, at least in part, to optimize the transmission gain.

In the case of an excitation means 21 positioned substantially in a mid-zone of the waveguide 200, the proximal end 201 and distal end 202 may advantageously have no closing means of the abovementioned type and be of open-ended type, remaining open.

Such an embodiment advantageously makes it possible to cut an end portion of the waveguide 200 in order to adjust this waveguide 200 to the dimensions of an object that it is desired to protect, of a zone that it is desired to delimit or of an opening that it is desired to fit it to.

An additional feature consists in that the transmit means 2 also comprises a means 23 for protecting the transmit antenna 20.

Such a protection means 23 consists of a means for covering at least a portion of the external face of the wall 203 of the waveguide 200 in which at least one opening (204; 204′) is made.

A preferred embodiment consists in that this covering means is made of an amagnetic material, preferably of little thickness, notably in the form of a film.

Specifically, this covering means advantageously makes it possible to prevent the obstruction of the openings (204; 204′), notably by insects, leaves, dust or other elements.

As mentioned above, the transmit antenna 20 adopts the form of a tubular waveguide 200, at least in part, consisting of a hollow section piece of parallelepipedal cross section.

According to a first embodiment, the transmit antenna 20 of such a waveguide 200 consists only of such a section piece (FIG. 7).

However, and according to a second embodiment, the antenna 20 of the transmit means 2 comprises at least one flange extending in the direction of the antenna 40 of the receive means 4, from the wall 203 of the waveguide 200 provided with at least one opening (204, 204′), more particularly in the extension of the walls of the waveguide 200 adjacent and perpendicular to the wall 203 comprising the opening or openings (204; 204′).

Such a flange preferably extends over the whole length of this waveguide 200.

Finally, the transmit means 2 may comprise a means 24 for directing the electromagnetic signal 3 toward the receive means 4.

As can be seen in FIG. 2, this means 24 for directing the electromagnetic signal 3 consists of two substantially parallel flanges (240; 240′) positioned on either side of the opening or openings (204; 204′) of the waveguide 200 of the transmit antenna 2.

In fact, these two flanges (240; 240′) extend in the direction of the receive means 4 and from the waveguide 200, more particularly from the wall 203 of the waveguide 200 provided with one or more openings (204; 204′).

More particularly, these flanges (240; 240′) are situated in the extension of the walls of the waveguide 200 adjacent and perpendicular to the wall 203 comprising the opening or openings (204; 204′).

With respect to the means 4 for receiving the electromagnetic signal 3, said means comprises, on the one hand, an antenna 40 for receiving such a signal 3 associated with a second terminal and, on the other hand, a means 41 for detecting such an electromagnetic signal 3.

This receive antenna 40 adopts the form of a tubular waveguide 400 made of a metal material, preferably of aluminum, and having a proximal end 401 and a distal end 402.

This tubular waveguide 400 consists, at least in part, of a section piece that is hollow and of parallelepipedal cross section (preferably rectangular or square) so that this waveguide 400 has a plurality of walls of which one 403 is oriented in the direction of the transmit means 2.

Here again, this hollow section piece of parallelepipedal cross section has internal, respectively external, dimensions corresponding to the (internal, respectively external) width of the walls of this waveguide 400.

In particular, the wall 403 oriented in the direction of the transmit means 2 (and the wall 407 of the waveguide 400 that is parallel with it) has a determined internal width (a) while the walls extending from such a wall 403 have a determined internal width (b), depending on the case, that is equal to (in the case of a waveguide 400 of square cross section) or different from (in the case of a waveguide 400 of rectangular cross section) the width (a).

As illustrated in FIG. 3, at least one wall of the waveguide 400 of this receive antenna 40 is provided with at least one opening (404; 404′).

The opening or openings (404; 404′) of the waveguide 400 of the receive antenna 40 have preferably similar (or preferably identical) features to those of the opening or openings (204; 204′) of the waveguide 200 of the transmit antenna 20, with the same effects and the same advantages.

In particular, this or these openings (404; 404′) are made in the wall 403 of the waveguide 400 oriented in the direction of the transmit means 2.

In fact, this waveguide 400 comprises a plurality of openings (404; 404′) preferably aligned in at least one row (405; 405′) of openings (404; 404′).

Here again, within such a row (405; 405′), the openings (404; 404′) are positioned substantially in a location where the electromagnetic field is at a maximum.

In particular, the pitch (p) between two successive openings (404; 404′) of one and the same row (405; 405′) is between 2 and 6 times the guided wavelength divided by 2 (2*λg/2≦p≦6*λg/2), preferably of the order of 4 times this guided wavelength divided by 2 (p≈4*λg/2).

Here again, this advantageously makes it possible to distribute the electromagnetic field over the whole length of the waveguide 400.

Preferably, this waveguide 400 comprises two rows (405; 405′), preferably parallel, of openings (404; 404′).

Here again, these two rows (405, 405′):
are spaced at a distance corresponding substantially to half the width (more particularly the internal width a) of the wall 403 provided with the openings (404; 404′) and/or;
extend on either side of an axis 406 (preferably parallel to this axis 406), this axis 406 preferably consisting of the median axis of the wall 403 provided with the openings (404; 404′) and contained in the waveguide 400.

Here again, the openings 404 of one row 405 are preferably offset longitudinally relative to the openings 404′ of the other row 405′.

This or these openings (404; 404′) may have any shape, for example circular or (and preferably) elongate, more particularly oval, diamond-shaped or (and preferably) slot-shaped (preferably rectangular).

The length (l) of this or these openings (404; 404′) preferably corresponds to half the wavelength λ(l=λ/2).

This or these elongate openings (404, 404′) and/or an alignment of these openings extend in a manner substantially parallel to the longitudinal direction of extension of the waveguide 400.

As mentioned above, the receive means 4 again comprises a means 41 for detecting an electromagnetic signal 3 transmitted by the transmit means 2.

Such a detection means 41 may consist of a low-consumption diode, more particularly a Schottky diode. The detection means 41 may also comprise a mixer circuit or an analog-digital converter followed by a signal-processing circuit.

It will be observed that the signal to be detected may have a low level so that this detection means 41 may be supplemented (notably preceded in the chain for processing the received signal) by an amplifier, more particularly a low-noise amplifier.

According to another feature, this detection means 41 is associated with the receive antenna 40 while being engaged (at least in part) inside this waveguide 400.

According to a first embodiment illustrated in FIGS. 1, 4, 5 and 6, this detection means 41 may be engaged inside this waveguide 400 at one end (notably the proximal end 401) of this waveguide 400.

In such a case, the receive means 4 may also comprise at least one means 42 for closing the waveguide 400. This closing means 42 is associated with at least one end (401, 402) of this waveguide 400 (more particularly with the distal end 402, opposite to the proximal end 401 at which the detection means 41 is inserted into the waveguide 400) and preferably consists of a means for producing a short circuit.

However, and according to a preferred embodiment of the invention illustrated in FIG. 7, the waveguide 400 of the receive antenna 40 receives internally the detection means 41 which is, on the one hand, engaged inside this waveguide 400 and, on the other hand, positioned in a mid-zone of this waveguide 400 between the proximal end 401 and the distal end 402 of this waveguide 400.

A preferred embodiment consists in that this detection means 41 is positioned substantially equidistant from the proximal end 401 and from the distal end 402 of this waveguide 400.

An additional feature consists in that the detection means 41 is then positioned close to an opening (404; 404′) with which the wall 403 of the waveguide 400 of the receive antenna 40 is provided in a mid-zone of this waveguide 400, preferably substantially equidistant from the proximal end 401 and from the distal end 402 of this waveguide 400.

Additionally, this detection means 41 is positioned in line with or through a through-orifice made in a wall 407 of the waveguide 400 parallel to the wall 403 provided with openings (404, 404′), in a mid-zone of this waveguide 400, preferably substantially equidistant from the proximal end 401 and from the distal end 402 of this waveguide 400.

In the case of a receive means 41 positioned substantially in a mid-zone of the waveguide 400, the proximal end 401 and distal end 402 may advantageously have no closing means of the abovementioned type and be of open-ended type, remaining open.

Additionally, the receive means 4 also comprises a means 43 for protecting the receive antenna 40. This protection means 43 consists, here again, of a means for covering at least a portion of the external face of the wall 403 of the waveguide 400 in which at least one opening (404; 404′) is made. This covering means is made of an amagnetic material, preferably of little thickness, notably in the form of a film.

As mentioned above, the receive antenna 40 adopts the form of a tubular waveguide 400, at least in part, consisting of a hollow section piece of parallelepipedal cross section.

According to a first embodiment, the receive antenna 40 of such a waveguide 400 consists only of such a section piece (FIG. 7).

However, and according to a second embodiment, the antenna 40 of the receive means 4 comprises at least one flange extending in the direction of the antenna 20 of the transmit means 2, from the wall 403 of the waveguide 400 provided with at least one opening (404, 404′), more particularly in the extension of the walls of the waveguide 400 adjacent and perpendicular to the wall 403 comprising the opening or openings (404; 404′).

Such a flange preferably extends over the whole length of this waveguide 400.

Finally, the receive means 4 may comprise a means 44 for directing the electromagnetic signal 3 toward the opening or openings (404; 404′) of the waveguide 400 of the receive antenna 40.

This means 44 for directing the electromagnetic signal 3 consists of two substantially parallel flanges (440; 440′) positioned on either side of the opening or openings (404; 404′), extending in the direction of the transmit means 2 and from the waveguide 400, more particularly from the wall 403 of the waveguide 400 comprising one or more openings (404; 404′).

More particularly, these flanges (440; 440′) are situated, here again, in the extension of the walls of the waveguide 400 adjacent and perpendicular to the wall 403 comprising the opening or openings (404; 404′).

According to another feature of the invention, the detection device 1 comprises at least one means 9 for electrically powering the transmit means 2 and the receive means 4.

A particular embodiment illustrated in FIG. 7 consists in that the device 1 then comprises at least one solar collector 90 fitted to the means 2 for transmitting an electromagnetic signal (more particularly the waveguide 200 that this means 2 comprises), respectively the means 4 for receiving this electromagnetic signal (more particularly the waveguide 400 that this means 4 comprises), in order to electrically supply the excitation means 21, respectively the detection means 41, that this transmit means 2, respectively this receive means 4, comprises. The presence of such a solar collector 90 advantageously makes it possible to make the detection device 1 self-sufficient in energy. The electric power supply means 9 may also comprise at least one battery 91.

An additional feature consists in that the detection device 1 comprises a means 5 for the management of the transmit means 2 and receive means 4.

A first embodiment illustrated in FIG. 1 represents a management means 5 connected (more particularly by wire), on the one hand, to the transmit means 2, more particularly to the excitation means 21 and, on the other hand, to the receive means 4, more particularly to the detection means 41.

This management means 5 comprises, on the one hand, a means for supplying the transmit means 2 and receive means 4 and, on the other hand, a means for controlling the supply of these transmit means 2 and receive means 4. Preferably, this management means 5 may also comprise a means for synchronizing (notably periodically and/or at regular intervals) the control of the supply of the receive means 4 with that of the transmit means 2.

Such an embodiment makes it possible to activate the transmit means 2 and receive means 4 only periodically and/or at regular intervals, in order to ensure a transmission and a reception periodically and/or at regular intervals. This advantageously makes it possible to limit and optimize the energy consumption of the device 1.

However, and according to a second embodiment illustrated in FIG. 7, this management means 5 comprises, on the one hand, a first element 50 with which the transmit means 2 is provided and, on the other hand, a second element 50′ with which the receive means 4 is provided.

According to another feature, this first element 50, respectively this second element 50′, comprises a means for ensuring a transmission periodically and/or at regular intervals, respectively a means for ensuring a reception periodically and/or at regular intervals, here again for limiting and optimizing the energy consumption.

Moreover, this first element 50 and/or this second element 50′ of this management means 5 comprise a means for synchronizing this first element 50 and this second element 50′ (more particularly the second element 50′ with the first element 50), for the purpose of synchronization of the receive means 4 with the transmit means 2. Such a synchronization means consists preferably of a synchronization algorithm for synchronizing the receive means 4 on the transmit means 2.

Another feature consists in that this first element 50, respectively this second element 50′, either comprises a means 9 (more particularly in the form of at least one solar collector as mentioned above) for the electrical supply of the transmit means 2, respectively of the receive means 4, or (and preferably as illustrated in FIG. 7) is associated (more particularly by wire link) to such an electrical supply means 9 (collector 90+battery 91).

Additionally, this first element 50, respectively this second element 50′, then comprises a means for controlling the electric power supply of this transmit means 2, respectively of this receive means 4.

An additional feature consists in that this first element 50, respectively this second element 50′, either comprises the excitation means 21, respectively the detection means 41, or is associated with this excitation means 21, respectively with this detection means 41.

In fact, such an element (first element 50 and/or second element 50′) may consist of an electronic device (notably standalone) incorporating at least a portion of the abovementioned means and adopting, more particularly, the form of an electronic circuit board or of a module receiving such a circuit board.

A preferred embodiment consists in that such an element (first element 50 and/or second element 50′) takes the form of an electronic circuit board with which the excitation means 21, respectively the detection means 41, is associated, which is positioned against such a circuit board (FIG. 7). Such an embodiment advantageously makes it possible to reduce the signal losses.

On this subject, it will be observed that, according to a preferred embodiment illustrated in FIG. 7, only the excitation means 21, respectively the detection means 41, is positioned inside the waveguide (200; 400) of the transmit means 2, respectively of the receive means 4 (FIG. 7). This excitation means 21, respectively this detection means 41, may then pass through a through-orifice made in a wall (207; 407) of this waveguide (200; 400), more particularly in a wall (207; 407) parallel to the wall (203; 403) provided with the openings (204, 204′; 404, 404′).

In such a case, the first element 50, respectively the second element 50′, is positioned outside this waveguide (200; 400), notably as an appliqué element against this wall (207; 407) parallel to the wall (203; 403) provided with the openings (204, 204′; 404, 404′).

Additionally, this management means 5 (more particularly the first element 50 and/or the second element 50′ that this management means 5 comprises) may also comprise a means for transmitting (more particularly by radiowave) an item of information (more particularly an item of control information) to a remote member, notably a visual and/or audible warning means 6, a motor 103 or similar element as will be described below.

Finally, the detection device 1 (more particularly its management means 5) may also comprise a means for analyzing a received signal SR (or the variations of this received signal SR) received by the receive means 4, in order to initiate, as necessary, an action that is appropriate and in connection with this received signal SR.

With respect to the received signal SR, the latter may consist, depending on the case, of an electromagnetic signal received by the receive antenna 40, by an electric signal supplied by the detection means 41 associated with this receive antenna 40 or else by a component of such an electric/electromagnetic signal (more particularly its power, its moment of reception, its phase, its frequency or other component).

Such an analysis may also be carried out as a function of a control signal SC which, depending on the case, may be:
an electric signal delivered to the excitation means 21 in order to excite the transmit antenna 20;
an electromagnetic signal supplied by the excitation means 21 to the transmit antenna 20;
a component of such an electric/electromagnetic signal, more particularly its power, its moment of transmission, its phase, its frequency or other component.

On this subject, it should be observed that the received signal SR and the control signal SC are connected by a transfer function FT of the SR=FT (SC) type.

In fact, such a transfer function FT is defined on the basis of the relative positioning of each of the two antennas (20; 40) and the structure of the latter. This transfer function FT depends, amongst other things, on the length, on the cross section, on the material of the waveguide (200; 400) and on the number of openings (204, 204′; 404, 404′), on their form, on their dimensions.

As nonlimiting examples, it is possible to envisage the following transfer functions FT:
power of the electric signal received as a function of the power of the electric signal transmitted;
transmission of an electric signal in the form of a pulse and receipt of a pulse, the transfer function then indicating the duration of “flight” of the pulse, that is to say the duration separating the two pulses;
transmission of an electric signal in the form of a ramp of frequencies (a signal is transmitted at an initial frequency fi and then the frequency is progressively increased up to a final frequency) and receipt after (electronic or hardware) filtering of a signal having a frequency fr between the initial and final frequencies, the transfer function then indicating for example the duration separating the moment of starting of the ramp and the moment of receipt of the frequency fr.

Finally, and according to an additional feature, the detection device 1 may also comprise a visual and/or audible warning means 6 connected (depending on the case, by wire or by radiowaves) to the management means 5 (more particularly to the analysis means that this management means 5 comprises), and capable of being activated by this management means 5, more particularly as a function of the characteristics of the received signal SR received by the receive means 4.

As will be described further on in the description, the invention also relates to a method for detecting the presence of an object or of a living being between two terminals.

This method is applied by the detection device 1 described above and consists:
according to a first step (the calibration phase), in determining the abovementioned transfer function FT and connecting a received signal SR to a control signal SC, in the absence of objects or of living beings in the surface barrier;
according to a second step (the usage phase), in analyzing a received signal SR by comparing this received signal SR with the transfer function FT that is expected and determined during the first step (more particularly for a given control signal SC), for the purpose of determining whether this received signal SR corresponds to the expected transfer function FT or differs therefrom;
according to a third step, in initiating an action if there is a difference.

On this subject, it will be observed that, during this second step, the method may also consist in analyzing, as necessary, the difference (notably the differential) between the received signal SR and the expected transfer function FT, for the purpose of determining the nature of the event corresponding to this difference and therefore of initiating (during the third step of the method) an action appropriate to the detected event.

The detection device 1 described above has technical features that confer on it a certain versatility making it possible advantageously to envisage its use in various fields.

Thus, this detection device 1 may be used in the context of protecting an object 7, more particularly an object of value such as a work of art.

The invention may therefore relate to an installation 8 for the protection of such an object 7, this installation 8 comprising, on the one hand, a device 1 for detecting the presence of a living being (more particularly the hand of a criminal) or of a tool (more particularly a grasping or similar tool) close to or in contact with this object 7. Such a device then allows the approach and/or the contact and/or the seizing of this object 7 to be detected.

Advantageously, this detection device 1 may have the abovementioned technical features and comprise at least one transmit means 2 and at least one receive means 4. These means (2; 4) are positioned on either side and in front of the object 7 (and/or at least one side of this object 7) to be protected and may each be associated with a terminal (or even forming or consisting of such a terminal) positioned close to this object.

Moreover, this installation 8 comprises a visual and/or audible warning means 6 designed to be actuated in the event of detection, by the detection device 1, of a living being or of a tool (more particularly of an approach to and/or a contact with and/or a seizing of this object 7 by such a living being or by such a tool).

The detection device 1 according to the invention may also be used for counting movable elements passing through a zone, more particularly delimited by two terminals.

On this subject, it will be observed that such movable elements may, for example, consist of living beings (notably passers-by, sportsmen or animals) or of objects in motion.

In such a case, the invention may therefore relate to an installation for counting a number of movable elements passing through a zone and comprising, on the one hand, a device 1 for detecting the passage of at least one element through this zone.

Advantageously, such a detection device 1 may have the abovementioned features and comprise at least one transmit means 2 and at least one receive means 4, these means (2; 4) being positioned on either side of the zone to be passed through.

Such a zone may be delimited by a security gate, on the one hand, designed to be passed through by the movable elements and, on the other hand, comprising lateral (notably vertical) uprights, more particularly in the form of terminals, delimiting this zone, and with which are associated (or even at least in part consisting of) the waveguides (200; 400) of the transmit means 2 and receive means 4.

Moreover, this installation comprises a device for counting the number of movable elements detected by the detection device 1. This counting device is then either connected to this detection device 1 (for example to the receive means 4 or to the management means 5), or incorporated into this device 1 (notably into the management device 5).

The detection device 1 according to the invention may also be used for association with an installation 10 for closing an opening 11 contained in a building 12 or a swimming pool 13.

On this subject, it should be observed that, in the case of a building 12, such an opening 11 is defined in the masonry 120 and may consist of a window, door, patio door, garage door or other opening.

In the case of a swimming pool 13, such an opening 11 is defined by a zone delimited by the internal contour of the top edge of the decks of this swimming pool 13. More particularly it is through such an opening 11 that it is possible to get into the swimming pool 13.

Such an opening 11 (of a building 12 or of a swimming pool 13) may be supplemented by an installation 10 designed to close and open this opening 11.

In a manner known per se, such an installation 10 usually comprises lateral runners (100; 100′) designed to be positioned facing one 100 another 100′, on either side of the opening 11.

Such a lateral runner (100; 100′) usually adopts a “U” shape and comprises at least, on the one hand a web and, on the other hand, two parallel flanges extending from this web.

Such an installation 10 also comprises an apron 101 designed to close the opening 11 and having lateral ends (1010; 1010′) installed slidingly inside the lateral runners (100; 100′).

In fact, such an apron 101 may consist of a mesh (more particularly in the case of a mosquito net or similar element) or of a part made of cloth and/or of synthetic material (more particularly in the case of an awning, a swimming pool cover or similar element). Such an apron 101 may also consist of a plurality of strips, notably articulated with one another, more particularly in the case of a roller blind or of a garage door.

According to the invention, such an installation 10 also comprises a detection device 1 having the technical features described above.

On this subject, it will be noted that this device 1 comprises transmit means 2 and receive means 4.

Therefore and according to a first embodiment of the present invention, these transmit means 2 and receive means 4 each consist, at least in part, of a lateral runner (100; 100′), that this closure installation 10 comprises.

Accordingly and as can be seen in FIGS. 1, 5 and 6, such a runner (100; 100′) comprises a hollow section piece (of parallelepipedal cross section, that is preferably rectangular or square) as mentioned above and forming a waveguide (200; 400).

Such a runner (100; 100′) also comprises a web forming the wall (203; 403) of a waveguide (200; 400), this wall (203; 403) being oriented in the direction of the receive means 4, respectively of the transmit means 2.

It is, more particularly, on the web of such a runner (100; 100′) that at least one opening (204, 204′; 404, 404′) as mentioned above is defined and that the transmit antenna 20 or the receive antenna 40 comprises.

Finally, such a runner (100; 100′) comprises two parallel flanges extending from the web and forming the two flanges (240, 240′; 440, 440′) of the detection device 1 as mentioned above and comprised by the means 24 for directing the electromagnetic signal 3 in the direction of the receive means 4, respectively the means 44 for directing this electromagnetic signal 3 in the direction of the openings (404; 404′) of the receive antenna 40.

However, and according to another embodiment illustrated in FIG. 7, the transmit means 2 and receive means 4 are distinct from such a lateral runner (100; 100′).

In a similar case, these transmit means 2 and receive means 4 extend parallel to such a lateral runner (100; 100′) and may be either positioned close to such a lateral runner (100; 100′) or else (FIG. 7) be fitted (directly or indirectly) to such a lateral runner (100; 100′).

This embodiment then advantageously makes it possible to fit a closure installation 10 that already exists with a detection device 1 according to the invention, or even to replace such a device 1 that has become defective.

Another advantage of this embodiment consists in that the distinction between, on the one hand, the transmit means 2 and the receive means 4 and, on the other hand, the lateral runners (100; 100′) advantageously makes it possible to prevent the spurious signals generated by the mechanical or electric elements associated with the operation of the apron 101 of the closure installation 10.

According to an additional feature, such a closure installation 10 may also comprise a means for detecting the presence of a movable element at the opening 11.

In fact, such a means for detecting presence consists of a detection device 1 that is described above and has the abovementioned features. This detection device 1 then comprises transmit means 2 and receive means 4 each consisting, at least in part, of a lateral runner (100; 100′) or extending parallel to such a lateral runner (100; 100′), close to such a lateral runner (100; 100′) or being fitted to such a lateral runner (100; 100′).

On this subject, it will be observed that such a detection means then makes it possible to detect the presence of a movable element at this opening 11, or even the passage of such a movable element through this opening 11.

Therefore, such a closure installation 10 provided with such a detection means may then advantageously be used for detecting:
the passage of an individual, more particularly during an attempt to break into a building 12;
the passage (notably the insertion) of a tool notably beneath the apron 101, or the setting in motion of this apron 101 during an attempt to break into a building 12;
a child falling into a swimming pool 13, etc.

Such a closure installation 10 may then comprise a means for detecting a break-in, this detection means advantageously being able to consist of a detection device 1 described above and having the abovementioned features.

This installation 10 will then more particularly be fitted to a building 12 having an opening 11 closed by a roller blind or a garage door.

Another feature of the closure installation 10 according to the invention consists in that it may also comprise, on the one hand, a means 102 for deploying and for folding the apron 101 and, on the other hand, a motor 103 for deriving this deployment/folding means 102.

On this subject, it will be observed that this deployment/folding means 102 may (more particularly in the case of a roller blind, of a mosquito net, of an awning or of a swimming pool cover) consist of a shaft onto which the apron 101 that the installation 10 comprises is rolled up and from which is unrolled.

This installation 10 then also comprises a means 104 for controlling the motor 103, this control means 104 more particularly being designed to control the starting and/or the stopping of this motor 103.

According to a first additional feature, this installation 10 also comprises a means for detecting an end-of-travel (top and/or bottom) of the apron 101 and/or a means for detecting an obstacle on the trajectory of this apron 101.

In fact and according to the invention, such a detection means (for detecting an end-of-travel or an obstacle) advantageously consists of a detection device 1 described above and having the abovementioned features.

This detection means is then connected to the means 104 for controlling the motor 103 which forms, in the event of detection, a means for controlling the stopping of this motor 103.

On this subject, it will be observed that a closure installation 10 provided with an obstacle-detection means may then advantageously be used for detecting the presence of an individual (notably a child), of an animal or of an object (for example a furniture item, a flower pot or other object) that is on the trajectory of the apron 101 when it is deployed.

According to a second additional feature, this closure installation 10 may comprise a means for detecting the position of the apron 101 of the installation 10, more particularly relative to the opening 11.

Here again, such a detection means may consist of a detection device 1 described above and having the abovementioned features.

This means for detecting the position of the apron 101 may be supplemented by a means that the installation 10 comprises and that is designed to record environmental parameters such as the brightness, the presence, the absence, the moving away or the approach of a movable element with respect to the installation 10, more particularly with respect to the opening 11 closed by this installation 10. Such a means for recording environmental parameters may also be designed to record meteorological parameters such as for example temperature, rain or sunshine.

As evoked above, this installation 10 comprises a motor 103 and a means 104 for controlling this motor 103. This control means 104 is then connected to the means for recording the environmental parameters and to the means for detecting the position of the apron 101.

Therefore it is more particularly as a function of the recorded environmental parameters and of the position of the apron 101 that this control means 104 will control the motor 103 for driving this apron 101 in order, as a function of these parameters and of this position, to deploy or fold this apron 101.

The closure installation 10 provided with such a parameter-recording means and with such a means for detecting the position of the apron 101 may then advantageously be used for recording a parameter such as:
the light outside and/or inside the building 12 for the purpose of controlling the motor 103 for an opening or a closing of the apron 101, more particularly of a roller blind, an awning or a mosquito net fitted to this building 12;
the presence or the approach of a motor vehicle for the purpose of controlling the opening of a garage door;
the absence or moving away of such a vehicle for the purpose of controlling the closing of such a garage door;
the rain or the temperature (notably of the air outside or inside a building, of the outside air or of the water of a swimming pool) for the purpose of controlling the opening or the closing of a roller blind, an awning, a mosquito net, a cover of a swimming pool 13 or similar element.

Naturally, the detection means corresponding to one or more of these two additional features (notably and according to one particular embodiment, to all of these additional features) and/or to the presence-detection means and/or to the break-in-detection means may advantageously be provided on one and the same installation 10 for closing an opening 11.

Advantageously, at least a portion (or even the totality) of these detection means may consist of a single detection device 1 according to the present invention and having the features described above.

A particular embodiment consists in that all of these detection means (advantageously defined by one and the same detection device 1) may be defined on an installation 10 for closing an opening 11 contained in a building 12, this installation 10 consisting of a roller blind or of an awning.

Finally, an installation 10 for closing an opening 11 as described above may also comprise a visual and/or audible warning means.

Such a warning means may be actuated in the event of the detection, by the detection device 1, depending on the case, of a presence of a movable element, of a break-in, of an end-of-travel or of an obstacle, this correlatively with the nature of the detection means and/or of the detected event.

As evoked above, the invention also relates to a method for detecting the presence of an object or of a living being between two terminals, this method being applied by the detection device 1 that is described above and that an installation (8, 10) as described above comprises.

This method comprises a first step consisting, as explained above, in determining the abovementioned transfer function FT and connecting a received signal SR to a control signal SC during a calibration phase.

On this subject, it is necessary to distinguish two types of detection devices 1 depending on whether or not the installation (8, 10) comprises an apron (101).

A first type corresponds to an installation 8 with no apron 101 and for which a “static” transfer function FT is determined, characterized in that, for a given control signal SC, it is expected that a given received signal SR be received. This received signal SR is connected to the control signal SC by an invariable transfer function FT, preferably of the linear type.

A second type corresponds to an installation 10 provided with an apron 101 that can open and close the opening 11.

In such a case, there is potentially an infinity of transfer functions FT depending on the position of the apron 101.

A “dynamic” transfer function FT is therefore defined which is in fact a function of the position of this apron 101.

As an example of a “dynamic” transfer function FT, it is possible to consider the transfer function FT corresponding to the power P of an electric signal. In such a case, the power of the received electric signal P(SR) is expressed, depending on the power of the control signal P(SC), according to the relation P(SR)=kP(SC) in which the parameter k is a function of the length l of the unrolled apron k(l).

As evoked above, this method comprises a second step consisting in analyzing the received signal SR relative to the expected transfer function FT and determined during the calibration step for at least one value of the control signal SC.

For an installation of the first type and having no apron 101, the analysis step consists in finding a significant difference between, on the one hand, the received signal SR (or a component of this signal such as its power) and, on the other hand, the signal that is expected and defined according to the predetermined transfer function FT.

For an installation of the second type and comprising an apron 101, the analysis step consists, on the one hand, in regularly monitoring/defining the position of the apron 101 and, on the other hand and in the case of detection of a difference between received signal SR and expected signal FT, in determining whether this difference corresponds to a normal movement of the apron 101 (detection of an insignificant difference) or to the presence of a living being or of an object on the trajectory of this apron 101 (detection of a significant difference).

In such a case, the benchmark transfer function FT in fact varies dynamically and the method consists, in the case of detection of a difference, in determining whether this difference corresponds (insignificant difference) or not (significant difference) to a possible variation of this transfer function FT, in order to detect the presence of a living being or of an object, more particularly in the case of detecting a significant difference.

As evoked above, the second step of analysis makes it possible to detect a significant difference between the received signal SR and the expected transfer function FT. In the case of detecting such a difference, this second step of the method consists, again and additionally, in analyzing this difference in order to identify (by means of an identification means that the detection device 1 comprises, more particularly its management means 5) the nature of the event corresponding to this difference and therefore in initiating (during the third step of the method) an action appropriate to the identified event.

On this subject and according to another feature, this method consists then also and prior to the use of an installation (more particularly during a calibration phase):
in causing various events (end-of-travel, obstacle, passage, break-in, etc.) and in recording the influence of such an event on the received signal SR. The modification of the received signal SR relative to an expected transfer function FT is specific to each event and constitutes the “signature” of this event. Such a “signature” may, for example, correspond to a form of difference as a function of time (sudden drops in power, or on the other hand a slight but prolonged drop in amplitude);
in establishing a correspondence between a determined “signature” and a determined event, or even in recording such a correspondence in a memory that the detection device 1 (more particularly its management means 5) comprises.

The second step of the analysis method consists, then and in the usage phase of an installation (8, 10):
in detecting a significant difference between the received signal SR and the expected transfer function FT;
in analyzing the “signature” corresponding to this difference;
in identifying the event corresponding to the analyzed “signature” depending on the previously established correspondence.

Finally and according to a third step of this method, an action is initiated that is appropriate to and corresponds to the detected event.

1-22. (canceled)

23. An installation for closing an opening contained in a building or a swimming pool and which comprises, on the one hand, lateral runners designed to be positioned facing one another, on either side of the opening and, on the other hand, an apron designed to close the opening and having lateral ends mounted slidingly inside the lateral runners, characterized in that it also comprises a device for detecting the position of the apron between two terminals, this detection device comprising:
a means for transmitting an electromagnetic signal comprising, on the one hand, a transmit antenna, associated with a first terminal, and adopting the form of a tubular waveguide having at least one wall provided with at least one opening and, on the other hand, a means for exciting this antenna for the purpose of transmitting such a signal via this antenna;
a means for receiving this electromagnetic signal comprising, on the one hand, a receive antenna, associated with a second terminal, adopting the form of a tubular waveguide having at least one wall provided with at least one opening and, on the other hand, a means for detecting such a signal;
a means for determining the position of the apron by analyzing a received signal received by the receive means as a function of a control signal from the transmit means, this received signal and this control signal being connected by a transfer function dependent on the position of the apron.

24. The installation for closing an opening as claimed in claim 23, characterized in that it also comprises a means for detecting a break-in or a presence of a movable element at the opening, this means for detecting a break-in or a presence consisting of the device for detecting the position of the apron.

25. The installation for closing an opening as claimed in claim 23, characterized in that it also comprises a means for detecting an obstacle on the trajectory of the apron or an end-of-travel of this apron, this means for detecting an obstacle or an end-of-travel consisting of the device for detecting the position of the apron.

26. The installation for closing an opening as claimed in claim 23, characterized in that it also comprises:
a motor for driving a means for the deployment and for the folding of the apron;
a means for detecting an obstacle on the trajectory of the apron or an end-of-travel of this apron, this means for detecting an obstacle or an end-of-travel consisting of the device for detecting the position of the apron;
a means, connected to the obstacle-detection or end-of-travel-detection means, for controlling the stopping of the drive motor if an obstacle or end-of-travel is detected.

27. The installation for closing an opening as claimed in claim 23, characterized in that it also comprises:
a motor for driving a means for the deployment and for the folding of the apron;
a means for recording environmental parameters, notably meteorological parameters;
a means, connected to the means for recording environmental parameters and to the device for detecting the position of the apron, for controlling the drive motor as a function of the recorded parameters and of the position of the apron.

28. The installation for closing an opening as claimed claim 23, characterized in that the transmit means and receive means each consist, at least in part, of a lateral runner or extend parallel to such a lateral runner, close to such a lateral runner or being fitted to such a lateral runner.

29. The installation for closing an opening as claimed in claim 23, characterized in that the waveguide of the transmit antenna, respectively the waveguide of the receive antenna, on the one hand, comprises a proximal end and a distal end and, on the other hand, receives internally the excitation means, respectively the detection means, which is positioned in a mid-zone of the waveguide between this proximal end and this distal end.

30. The installation for closing an opening as claimed in claim 23, characterized in that the excitation means, respectively the detection means, is positioned close to an opening with which the wall of the waveguide of the transmit antenna, respectively of the receive antenna, is provided, in a mid-zone of this waveguide, or even also positioned in line with or through a through-orifice made in a wall of the waveguide parallel to the wall provided with openings, in a mid-zone of this waveguide.

31. The installation for closing an opening as claimed in claim 29, characterized in that the waveguide of the transmit antenna, respectively the waveguide of the receive antenna, comprises a proximal end and a distal end of the open-ended type.

32. The installation for closing an opening as claimed in claim 23, characterized in that the waveguide of the transmit antenna, respectively of the receive antenna, comprises, on the one hand, a proximal end inside which the excitation means, respectively the detection means, is engaged, and, on the other hand, a distal end with which is associated a means for the closure of this waveguide.

33. The installation for closing an opening as claimed in claim 23, characterized in that the opening or openings are made in a wall of the waveguide of the transmit antenna, respectively of the receive antenna, oriented in the direction of the receive antenna, respectively the transmit antenna.

34. The installation for closing an opening as claimed in claim 23, characterized in that the opening or openings have an elongate shape and extend in a manner substantially parallel to the longitudinal direction of extension of the waveguide in which such an opening is made.

35. The installation for closing an opening as claimed in claim 34, characterized in that the opening or openings adopt the form of a slot, preferably rectangular, and have a length corresponding substantially to half the wavelength.

36. The installation for closing an opening as claimed in claim 23, characterized in that, on the one hand, the wall of the tubular waveguide is provided with a plurality of openings aligned in at least one row of openings and in that, on the other hand, the openings of one and the same row are positioned substantially in a location where the electromagnetic field is at a maximum.

37. The installation for closing an opening as claimed in claim 23, characterized in that, on the one hand, the wall of the tubular waveguide is provided with a plurality of openings aligned in at least one row of openings and in that, on the other hand, the pitch between two successive openings of one and the same row is between 2 and 6 times the guided wavelength divided by 2 (2*λg/2≦p≦6*λg/2), preferably of the order of 4 times this guided wavelength divided by 2 (p≈4*λg/2).

38. The installation for closing an opening as claimed in claim 23, characterized in that, on the one hand, the wall of the tubular waveguide is provided with a plurality of openings aligned in two parallel rows of openings and in that, on the other hand, the two rows extend on either side of an axis, preferably consisting of the median axis of the wall of the waveguide, and/or are spaced at a distance corresponding substantially to half the width of this wall.

39. The installation for closing an opening as claimed in claim 23, characterized in that the transmit means, respectively the receive means, comprise a means for the protection of the transmit antenna, respectively of the receive antenna.

40. The installation for closing an opening as claimed in claim 23, characterized in that the antenna of the transmit means comprises a means for directing the electromagnetic signal toward the antenna of the receive means.

41. The installation for closing an opening as claimed in claim 23, characterized in that the antenna of the transmit means, respectively the antenna of the receive means, comprises at least one flange extending in the direction of the antenna of the receive means, respectively in the direction of the antenna of the transmit means, from the wall of the waveguide provided with at least opening.

42. The installation for closing an opening as claimed in claim 23, characterized in that it comprises at least one solar collector fitted to the means for transmitting an electromagnetic signal, respectively the means for receiving this electromagnetic signal, in order to electrically supply the excitation means, respectively the detection means, that this transmit means, respectively this receive means, comprises.

43. The installation for closing an opening as claimed in claim 23, characterized in that it comprises a means for the management of the transmit means and receive means, this management means comprising means for ensuring a transmission and a reception periodically and/or at regular intervals.
